(19) United States
(12) Patent Application Publication
(10) Pub. No.: US 2018/0375183 A1
(43) Pub. Date: Dec. 27, 2018

(54) ANTENNA DEVICE

(71) Applicant: MITSUBISHI ELECTRIC CORPORATION, Tokyo (JP)

(72) Inventors: Jun GOTO, Tokyo (JP); Satoshi YAMAGUCHI, Tokyo (JP); Masataka OTSUKA, Tokyo (JP)

(73) Assignee: MITSUBISHI ELECTRIC CORPORATION, Tokyo (JP)

(21) Appl. No.: 16/066,263

(22) PCT Filed: Feb. 5, 2016
(86) PCT No.: PCT/JP2016/053515

§ 371 Date: Jun. 26, 2018

(51) Int. Cl. H01P 3/08; H01Q 13/10; H01Q 13/18; H01Q 21/06; H01Q 1/40; H01Q 21/00

(52) U.S. Cl. CPC H01P 3/085; H01Q 13/106; H01Q 21/0081; H01Q 21/064; H01Q 1/40; H01Q 13/18

(57) ABSTRACT

A ground conductor (1) having slots (2a to 2g) for radiating electromagnetic waves, a ground conductor (3) in which cavities (4) recessed in a direction away from the ground conductor (1) is formed in positions opposite to the slots (2a to 2g) of the grounding conductor (1), and central conductors (5a, 5b, 6a to 6c, 7a, and 7b) arranged in positions overlapping with the slots (2a to 2g), respectively, between the ground conductor (1) and the ground conductor (3) are provided. The central conductors (5a, 5b, 6a to 6c, 7a, and 7b) are arranged such that the ground conductor (1) is closer to them than the ground conductor (3).

### TECHNICAL FIELD

The present invention relates to an antenna device in which a triplate line is used as a feeder line.

### BACKGROUND ART

An antenna device disclosed in Non-Patent Literature 1 listed below includes a triplate line formed of an upper ground plate in which an aperture is formed, a lower ground plate, and a strip line arranged between the upper ground plate and the lower ground plate.

Since electromagnetic waves propagating through the triplate line have a small attenuation amount and are in a stable state, it is difficult for the electromagnetic waves to radiate from the aperture formed in the upper ground plate. Thus, a cavity is formed in the lower ground plate in a position opposite to the aperture formed in the upper ground plate. This cavity is a recessed portion recessed in a direction away from the upper ground plate.

Since the cavity is formed in the lower ground plate, the stable state is broken, so that electromagnetic waves are radiated from the aperture formed in the upper ground plate.

The antenna device disclosed in Patent Literature 1 listed below is further provided with a third conductor plate and a second feeder line in addition to a first conductor plate corresponding to the above-described upper ground plate, a second conductor plate corresponding to the above-described lower ground plate, and a first feeder line corresponding to the above-described strip line, and the triplate line is formed to have a two-layered configuration.

Also in this antenna device, a cavity is formed in the second conductor plate in a position opposite to an aperture formed in the first conductor plate.

### CITATION LIST

### Patent Literatures

Patent Literature 1: JP 1996-130410 A (FIG. 1)

### Non-Patent Literature

Non-Patent Literature 1: Nakayama, Nakano, “A Triplate-Type Aperture Antenna Backed by a Cavity” Journal of the Institute of Electronics, Information and Communication Engineers B, Vol. J82-B, No. 3, pp. 410-419, March 1999.

### SUMMARY OF INVENTION

### Technical Problem

Since conventional antenna devices are configured as described above, it is possible to brake the stable state by the cavity formed in the lower ground plate. However, in order to break the stable state, the depth of the cavity of approximately 0.25 wavelength is required. Therefore, there is a problem that the triplate line serving as the feeder line of the antenna device becomes thick.

The present invention is made to solve the above-described problem, and an object thereof is to provide an antenna device capable of reducing the thickness of a feeder line.

### Solution to Problem

An antenna device according to the present invention includes: a first ground conductor having an aperture for radiating an electromagnetic wave; a second ground conductor in which a cavity recessed in a direction away from the first ground conductor is formed in a position opposite to the aperture of the first ground conductor; and a first central conductor arranged between the first ground conductor and the second ground conductor in a position overlapping with the aperture. The first central conductor is arranged such that the first ground conductor is closer to the first central conductor than the second ground conductor.

### Advantageous Effects of Invention

According to the present invention, since the first central conductor is arranged such that the first ground conductor is closer to the first central conductor than the second ground conductor, there is an effect that the thickness of the feeder line composed of the first and second ground conductors and the first central conductor can be reduced.

### BRIEF DESCRIPTION OF DRAWINGS

FIG. 1 is a perspective view illustrating an antenna device according to a first embodiment of the present invention;

FIG. 2 is a top view illustrating the antenna device according to the first embodiment of the present invention;

FIG. 3 is a top view illustrating the antenna device in a state in which a ground conductor 1 is removed from the antenna device in FIG. 2 and central conductors 5, 6, and 7 are visible;

FIG. 4 is a cross-sectional view taken along line A-A′ in the antenna device in FIG. 2;

FIG. 5 is a cross-sectional view taken along line B-B′ in the antenna device in FIG. 2;

FIG. 6 is a top view illustrating an antenna device according to a second embodiment of the present invention;

FIG. 7 is a cross-sectional view taken along line A-A′ in the antenna device in FIG. 6;

FIG. 8 is a cross-sectional view taken along line A-A′ in the antenna device in FIG. 6;

FIG. 9 is a cross-sectional view taken along line A-A′ in the antenna device in FIG. 6;

FIG. 10 is a top view illustrating an antenna device according to a third embodiment of the present invention;

FIG. 11 is a top view illustrating an antenna device according to a fourth embodiment of the present invention;

FIG. 12 is a cross-sectional view taken along line B-B′ in the antenna device in FIG. 11;

FIG. 13A is a diagram for explaining reflection characteristics of the horizontal polarization A and reflection characteristics of the vertical polarization B; FIG. 13B is a diagram for explaining frequency characteristics of the main polarization gain C and frequency characteristics of the cross polarization gain D in the boresight direction at the time of horizontal polarization excitation; and FIG. 13C is a diagram for explaining frequency characteristics of the main polarization gain E and frequency characteristics of the cross polarization gain F in the boresight direction at the time of vertical polarization excitation; and

FIG. 14 is a top view illustrating an antenna device according to the fourth embodiment of the present invention.

### DESCRIPTION OF EMBODIMENTS

Some embodiments of the present invention will be described hereinafter with reference to the accompanying drawings in order to describe the present invention in more detail.

### First Embodiment

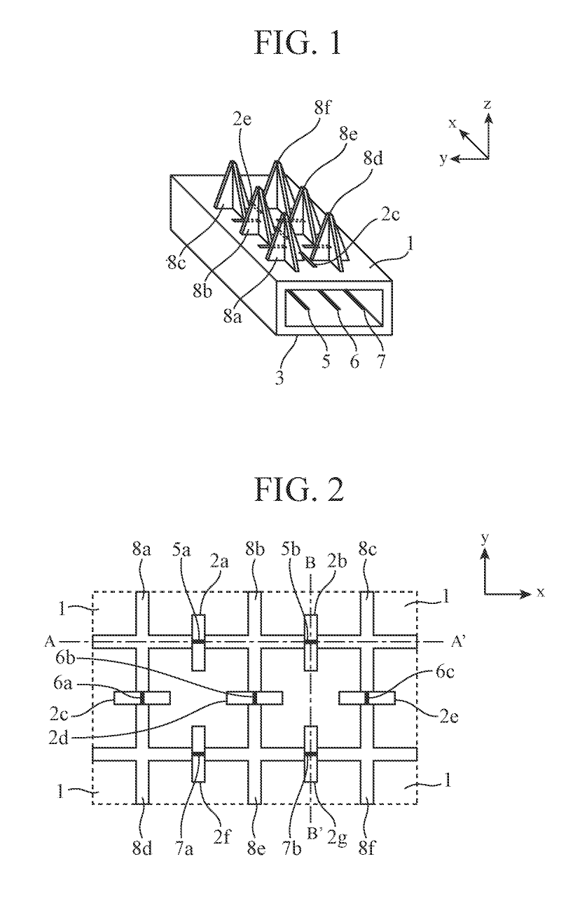

FIG. 1 is a perspective view illustrating an antenna device according to a first embodiment of the present invention, and FIG. 2 is a top view illustrating the antenna device according to the first embodiment of the present invention.

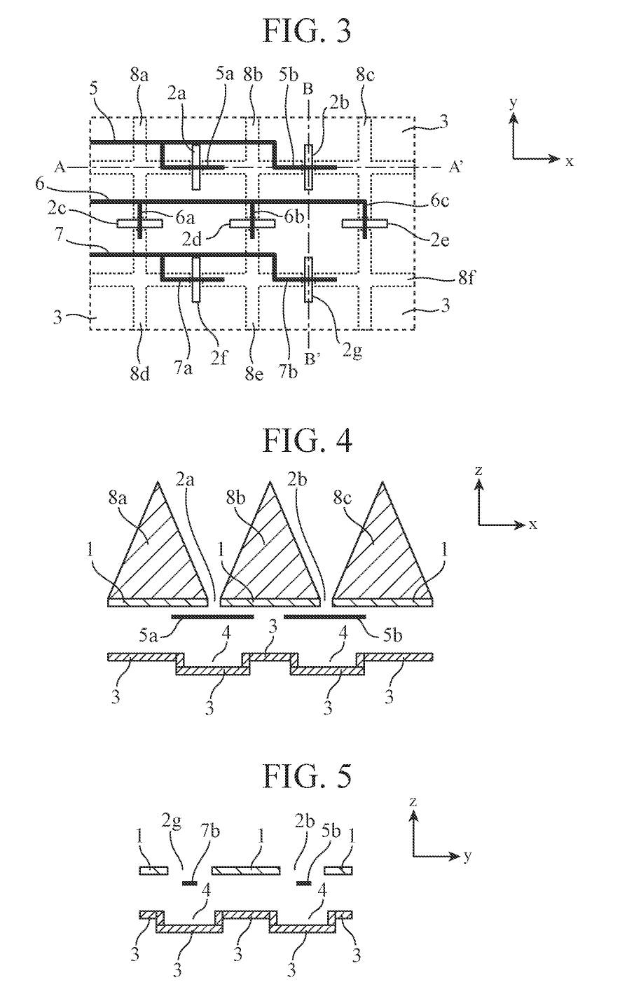

FIG. 3 is a top view illustrating the antenna device in a state in which a ground conductor 1 is removed from the antenna device in FIG. 2 and central conductors 5, 6, and 7 are visible, FIG. 4 is a cross-sectional view taken along line A-A′ of the antenna device in FIG. 2, and FIG. 5 is a cross-sectional view taken along line B-B′ of the antenna device in FIG. 2.

In FIGS. 1 to 5, the ground conductor 1 is a first ground conductor having apertures for radiating electromagnetic waves.

Slots 2a to 2g are apertures formed in the ground conductor 1 and electromagnetic waves are radiated from the slots 2a to 2g to the space.

A ground conductor 3 is a second ground conductor.

In the ground conductor 3, cavities 4 are formed to be recessed in a direction away from the ground conductor 1 in positions opposite to the slots 2a to 2g formed in the ground conductor 1. In an example in FIG. 4, the cavities 4 are formed in the ground conductor 3 to be recessed downward on the drawing sheet.

The central conductors 5, 6, and 7 are first central conductors arranged between the ground conductor 1 and the ground conductor 3.

The central conductor 5 includes a central conductor 5a branched from an intermediate point of the central conductor 5 and a central conductor 5b formed by bending an end of the central conductor 5. The central conductor 6 includes central conductors 6a and 6b each branched from an intermediate point of the central conductor 6 and a central conductor 6c formed by bending an end of the central conductor 6. The central conductor 7 includes a central conductor 7a branched from an intermediate point of the central conductor 7 and a central conductor 7b formed by bending an end of the central conductor 7. In an example in FIG. 3, the ends of the central conductors 5, 6, and 7 are on the right side on the drawing sheet.

The central conductor 5a is arranged in a position overlapping with the slot 2a, and the central conductor 5b is arranged in a position overlapping with the slot 2b. The central conductor 6a is arranged in a position overlapping with the slot 2c, the central conductor 6b is arranged in a position overlapping with the slot 2d, and the central conductor 6c is arranged in a position overlapping with the slot 2e. The central conductor 7a is arranged in a position overlapping with the slot 2f, and the central conductor 7b is arranged in a position overlapping with the slot 2g.

The central conductors 5a, 5b, 6a, 6b, 6c, 7a, and 7b are arranged such that the ground conductor 1 is closer to them than the ground conductor 3.

Tapered conductors 8a to 8f are connected to an upper side of the ground conductor 1.

Each of the tapered conductors 8a to 8f has a cross shape as illustrated in FIGS. 2 and 3 when the antenna device is seen from above, and has a triangular shape as illustrated in FIG. 4 when the antenna device is seen from a side thereof.

The tapered conductors 8a to 8f are mounted in order to widen the band of the antenna device. In a case in which the widening of the band is not required, it is not necessary to mount the tapered conductors 8a to 8f.

Next, the operation of the antenna device will be described.

The antenna device of the first embodiment includes a triplate line formed of the ground conductor 1 in which the slots 2a to 2g are formed, the ground conductor 3 in which the cavities 4 are formed, and the central conductor 5 arranged between the ground conductor 1 and the ground conductor 3. This antenna device also includes a triplate line formed of the ground conductor 1, the ground conductor 3, and the central conductor 6, and a tri-plate line formed of the ground conductor 1, the ground conductor 3, and the central conductor 7.

These triplate lines are used as feeder lines of the antenna device, and electromagnetic waves propagating through the triplate lines are in a stable state with a small attenuation amount. In the stable state, it is difficult to radiate the electromagnetic waves from the slots 2a to 2g formed in the ground conductor 1 to the space.

In order to operate the device as an antenna, it is necessary to radiate electromagnetic waves from the slots 2a to 2g formed in the ground conductor 1 to the space.

Therefore, the cavity 4 is formed in the ground conductor 3 in order to break the stable state. However, in order to break the stable state only by the cavity 4, a depth of the cavity 4 of approximately 0.25 wavelength is required, so that the triplate line serving as the feeder line becomes thick.

Therefore, in this first embodiment, in order to break the stable state even in a case in which the depth of the cavity 4 is designed to be small, the central conductors 5a, 5b, 6a, 6b, 6c, 7a, and 7b are arranged such that the ground conductor 1 is closer to them than the ground conductor 3.

By arranging the central conductors 5a, 5b, 6a, 6b, 6c, 7a, and 7b such that the ground conductor 1 is closer to them than the ground conductor 3 in this manner, the slots 2a to 2g serving as discontinuous points in the ground conductor 1 approach the central conductors 5a, 5b, 6a, 6b, 6c, 7a, and 7b, respectively, so that an electromagnetic field in the triplate line is disturbed by the effect of the discontinuous points, and the stable state can be broken.

For example, when the distance between the ground conductor 1 and the ground conductor 3 is 0.03 wavelength, by setting the distance between the central conductors 5a, 5b, 6a, 6b, 6c, 7a, and 7b and the ground conductor 1 to approximately 0.01 wavelength, the stable state can be broken even when the depth of the cavity 4 is about 0.08 wavelength.

Note that, in a case in which the central conductors 5a, 5b, 6a, 6b, 6c, 7a, and 7b are arranged in the center between the ground conductor 1 and the ground conductor 3, the depth of the cavity 4 of approximately 0.25 wavelength is required in order to break the stable state.

As can be understood from the above description, according to the first embodiment, the central conductors 5a, 5b, 6a, 6b, 6c, 7a, and 7b are arranged such that the ground conductor 1 is closer to them than the ground conductor 3, so that there is an effect that the stable state is broken and electromagnetic waves can be radiated from the slots 2a to 2g to the space even in a case in which the thickness of the feeder lines formed of the ground conductors 1 and 3 and the central conductors 5a, 5b, 6a, 6b, 6c, 7a, and 7b is designed to be small.

In this first embodiment, an example in which each of the slots 2a to 2g has a rectangular shape is described. However, its shape is not limited thereto, and the shape of each of the slots 2a to 2g may be the shape of the letter H, for example.

Further, the shape of each of the slots 2a to 2g may be a shape whose end parts are rounded.

For example, in a case in which the slots 2a to 2g are formed by machine cutting, the end parts of the slots 2a to 2g may be rounded.

In this first embodiment, each antenna element in the antenna device includes a slot 2 and a central conductor. That is, the slot 2a and the central conductor 5a form one antenna element, and the slot 2b and the central conductor 5b form one antenna element.

Further, the slot 2c and the central conductor 6a form one antenna element, the slot 2d and the central conductor 6b form one antenna element, and the slot 2e and the central conductor 6c form one antenna element.

Moreover, the slot 2f and the central conductor 7a form one antenna element, and the slot 2g and the central conductor 7b form one antenna element.

In this first embodiment, an example is illustrated in which the seven antenna elements form a two-dimensional array including two rows in the x-direction and three columns in the y-direction, but this is merely an example; it is possible to arrange any number of antenna elements in the x-direction and the y-direction.

The two-dimensional arrangement of the antenna elements as described above is similar in each of second to fourth embodiments described below.

### Second Embodiment

In the first embodiment described above, a configuration for breaking the stable state is shown, in which the central conductors 5a, 5b, 6a, 6b, 6c, 7a, and 7b are arranged such that the ground conductor 1 is closer to them than the ground conductor 3. However, in order to break the stable state, it is also possible to provide a disturbing conductor to disturb an electromagnetic field between the ground conductor 1 and the ground conductor 3.

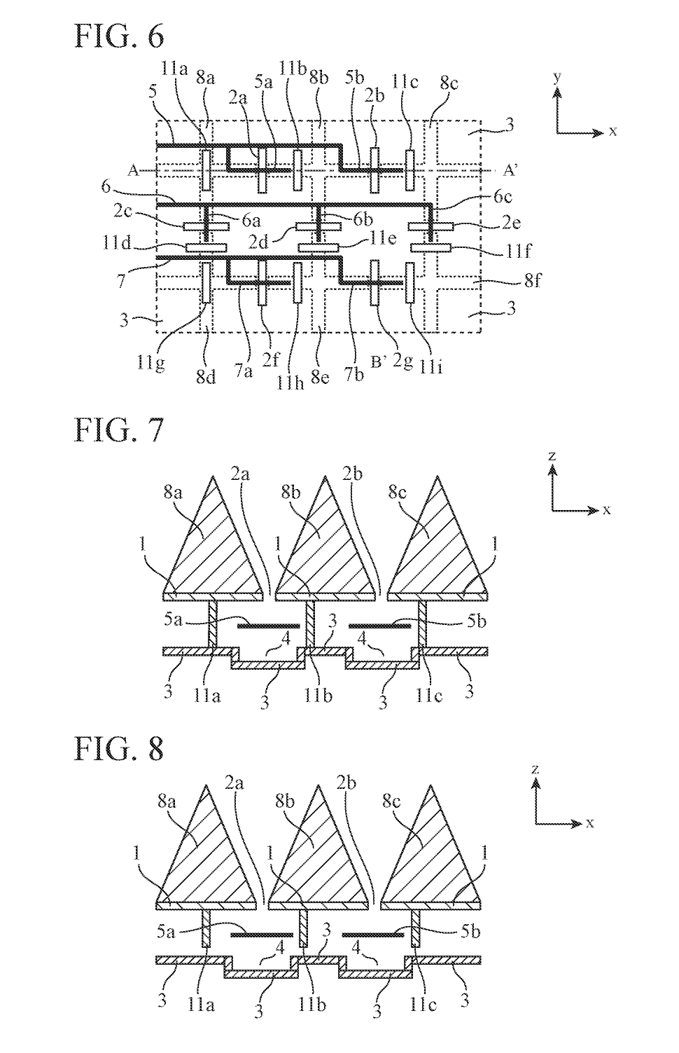

FIG. 6 is a top view illustrating an antenna device according to a second embodiment of the present invention. Note that, in FIG. 6, a state in which a ground conductor 1 is removed from the antenna device so that central conductors 5, 6, and 7 are visible is illustrated.

FIG. 7 is a cross-sectional view taken along line A-A′ in the antenna device of FIG. 6. Note that, FIG. 7 illustrates the antenna device in a state in which the ground conductor 1 is not removed.

In FIGS. 6 and 7, the same reference signs as those in FIGS. 1 to 5 represent the same or corresponding parts, so that the description thereof is omitted.

Ground conductors 11a to 11i are third ground conductors. One end of each of the third ground conductors is connected to the ground conductor 1 and the other end thereof is connected to the ground conductor 3. The ground conductors 11a to 11i are used as disturbing conductors to disturb an electromagnetic field between the ground conductor 1 and the ground conductor 3.

Next, the operation of the device in this embodiment will be described.

In order to break a stable state even when the depth of the cavity 4 is small, thereby radiating electromagnetic waves from slots 2a to 2g formed in the ground conductor 1 to the space, in the second embodiment, the ground conductors 11a to 11i are provided in the vicinity of the slots 2a to 2g as conductors for disturbing the electromagnetic field between the ground conductor 1 and the ground conductor 3. The ground conductors 11a to 11i serve as discontinuous points when electromagnetic waves propagate.

By this configuration, an electromagnetic field in a triplate line is disturbed by an effect of the discontinuous points provided by the ground conductors 11a to 11i, so that the stable state can be broken. As a result, it becomes possible to radiate electromagnetic waves from the slots 2a to 2g to the space.

As can be understood from the above description, according to the second embodiment, the ground conductors 11a to 11i whose one ends are connected to the ground conductor 1 and the other ends are connected to the ground conductor 3, respectively, are provided between the ground conductors 1 and 3 as the conductors for disturbing the electromagnetic field. As a result, there is an effect that the stable state is broken and the electromagnetic waves can be radiated from the slots 2a to 2g to the space, even in a case in which the thickness of each of the feeder lines formed of the ground conductors 1 and 3 and the central conductors 5a, 5b, 6a, 6b, 6c, 7a, and 7b is designed to be small.

In the second embodiment, an example in which the central conductors 5a, 5b, 6a, 6b, 6c, 7a, and 7b are arranged in the center between the ground conductor 1 and the ground conductor 3 is described. Further, as similar to the first embodiment, the central conductors 5a, 5b, 6a, 6b, 6c, 7a, and 7b may be arranged such that the ground conductor 1 is closer to them than the ground conductor 3. In this case, the number of elements which break the stable state increases, so that it is possible to break the stable state even when the depth of the cavity 4 is designed to be further small. As a result, it is possible to design the thickness of the feeder line of the antenna device to be further small.

In the second embodiment, an example in which the ground conductors 11a to 11i whose one ends are connected to the ground conductor 1 and the other ends are connected to the ground conductor 3, respectively, are provided between the ground conductor 1 and the ground conductor 3 as the conductors for disturbing the electromagnetic field is described. Alternatively, the configuration illustrated in FIG. 8 may be adopted, in which, although one end of each of the ground conductors 11a to 11i is connected to the ground conductor 1, the other end thereof is not connected to the ground conductor 3 but extends to the vicinity of the ground conductor 3.

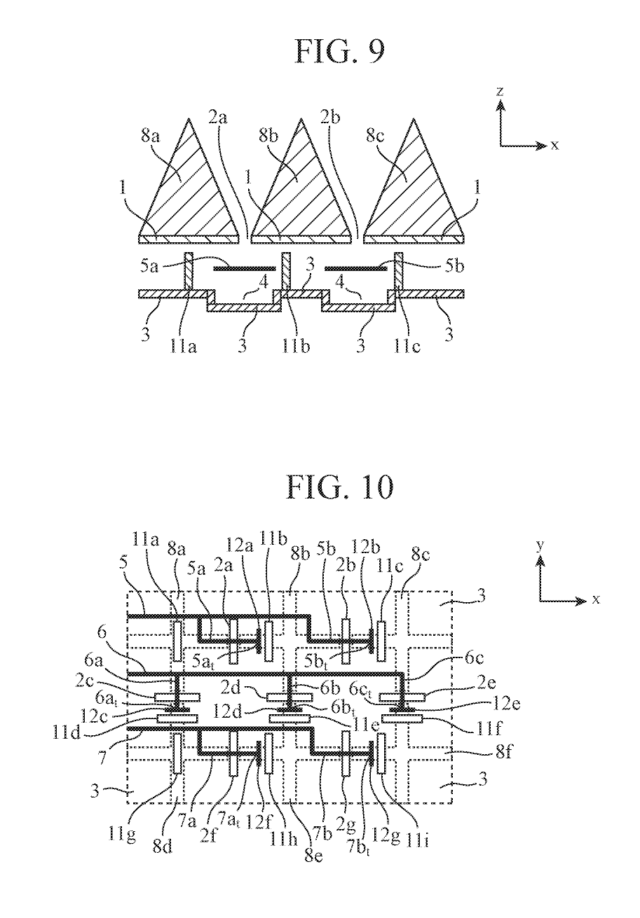

Further, the configuration illustrated in FIG. 9 may be adopted, in which, although the other end of each of the ground conductors 11a to 11i is connected to the ground conductor 3, one end thereof is not connected to the ground conductor 1 but extends to the vicinity of the ground conductor 1.

FIGS. 8 and 9 are cross-sectional views taken along line A-A′ of the antenna device in FIG. 6. Note that, in FIGS. 8 and 9, the antenna device in a state in which the ground conductor 1 is not removed is illustrated.

In this manner, even in cases in which one end or the other end of each of the ground conductors 11a to 11i are not connected to the ground conductor 1 or 3, the ground conductors 11a to 11i serve as discontinuous points when electromagnetic waves propagate. As a result, it is possible to break the stable state as in the case in which both ends thereof are connected thereto.

In the second embodiment, an example in which each of the ground conductors 11a to 11i is plate-shaped is described. However, the shape is not limited to the plate shape, and each of the ground conductors 11a to 11i may be bar-shaped, for example.

### Third Embodiment

In the above-described second embodiment, the ground conductors 11a to 11i whose one ends are connected to the ground conductor 1 and the other ends are connected to the ground conductor 3, respectively, are provided between the ground conductor 1 and the ground conductor 3 as the conductors for disturbing the electromagnetic field. Alternatively, another configuration may be adopted in which second central conductors are connected to the ends of the central conductors 5a, 5b, 6a, 6b, 6c, 7a, and 7b, respectively, as disturbing conductors.

FIG. 10 is a top view illustrating an antenna device according to a third embodiment of the present invention. Note that, in FIG. 10, a state in which a ground conductor 1 is removed from the antenna device and central conductors 5, 6, and 7 are visible is illustrated.

In FIG. 10, the same reference signs as those in FIGS. 3 and 6 represent the same or corresponding parts, so that the description thereof is omitted.

Central conductors 12a, 12b, 12c, 12d, 12e, 12f, and 12g are used as disturbing conductors for disturbing an electromagnetic field between the ground conductor 1 and a ground conductor 3.

The central conductors 12a and 12b are the second central conductors connected to ends 5aₜ and 5bₜ of central conductors 5a and 5b at the right angle with respect to the central conductors 5a and 5b, respectively, to be arranged in the same plane as the central conductors 5a and 5b.

The central conductors 12c, 12d, and 12e are the second central conductors connected to ends 6aₜ, 6bₜ, and 6cₜ of central conductors 6a, 6b, and 6c at the right angle with respect to the central conductors 6a, 6b, and 6c, respectively, to be arranged in the same plane as the central conductors 6a, 6b, and 6c.

The central conductors 12f and 12g are the second central conductors connected to ends 7aₜ and 7bₜ of central conductors 7a and 7b at the right angle with respect to the central conductors 7a and 7b, respectively, to be arranged in the same plane as the central conductors 7a and 7b.

Next, the operation of the antenna device in this embodiment will be described.

In order to break a stable state so that electromagnetic waves can be radiated from slots 2a to 2g formed in the ground conductor 1 to the space even when the depth of the cavities 4 is small, in the third embodiment, the central conductors 12a to 12g are provided as the conductors for disturbing the electromagnetic field between the ground conductor 1 and the ground conductor 3. The central conductors 12a to 12g serve as discontinuous points when electromagnetic waves propagate.

By this configuration, the electromagnetic field in a triplate line is disturbed by an effect of the discontinuous points provided by the central conductors 12a to 12g, so that the stable state can be broken. As a result, it becomes possible to radiate the electromagnetic waves from the slots 2a to 2g to the space.

As can be understood from the above description, according to the third embodiment, the central conductors 12a to 12g connected to the ends 5aₜ, 5bₜ, 6aₜ, 6bₜ, 6cₜ, 7aₜ, and 7bₜ of the central conductors 5a, 5b, 6a, 6b, 6c, 7a, and 7b and arranged in the same plane as the central conductors 5a, 5b, 6a, 6b, 6c, 7a, and 7b are provided as the conductors for disturbing the electromagnetic field between the ground conductors 1 and 3. As a result, even in a case in which the thickness of each of feeder lines formed of the ground conductors 1 and 3 and the central conductors 5a, 5b, 6a, 6b, 6c, 7a, and 7b is designed to be small, there is an effect that the stable state is broken and electromagnetic waves can be radiated from the slots 2a to 2g to the space.

In this third embodiment, an example in which the central conductors 12a to 12g are connected to the ends 5aₜ, 5bₜ, 6aₜ, 6bₜ, 6cₜ, 7aₜ, and 7bₜ of the central conductors 5a, 5b, 6a, 6b, 6c, 7a, and 7b, respectively, is described. Further, the central conductors 5a, 5b, 6a, 6b, 6c, 7a, and 7b may also be arranged such that the ground conductor 1 is closer to them than the ground conductor 3 as similar to the above-described first embodiment. In this case, the number of elements which break the stable state increases, so that it is possible to break the stable state even when the depth of the cavity 4 is designed to be further small. As a result, it is possible to design the thickness of the feeder line of the antenna device to be further small.

Moreover, as in the above-described second embodiment, ground conductors 11a to 11i may be provided between the ground conductor 1 and the ground conductor 3. In the example in FIG. 10, the ground conductors 11a to 11i are provided. By this configuration, the number of elements which break the stable state increases, so that it is possible to break the stable state even when the depth of the cavity 4 is designed to be further small. As a result, it is possible to design the thickness of the feeder line of the antenna device to be further small.

In the third embodiment, an example in which the central conductors 12a to 12g are connected at the right angle to the ends 5aₜ, 5bₜ, 6aₜ, 6bₜ, 6cₜ, 7aₜ, and 7bₜ of the central conductors 5a, 5b, 6a, 6b, 6c, 7a, and 7b, respectively, is described. However, it is only required for the central conductors 12a to 12g to serve as discontinuous points when electromagnetic waves propagate, and the connection angle is not limited to the right angle. Therefore, for example, the central conductors 12a to 12g may also be connected to the ends 5aₜ, 5bₜ, 6aₜ, 6bₜ, 6cₜ, 7aₜ, and 7bₜ of the central conductors 5a, 5b, 6a, 6b, 6c, 7a, and 7b, respectively, at the angle of 45 degree or 60 degree, for example.

### Fourth Embodiment

Generally, in an isolated triplate line, an electromagnetic field is concentrated in the vicinity of the central conductor. However, in a case in which the central conductors 5, 6, and 7 are arranged to be close to one another or in a case in which discontinuous portions such as the slots 2a to 2g and the cavities 4 are present as in a case of the antenna devices according to any of the above-described first to third embodiments, electromagnetic waves called as the parallel-plate mode may be generated between the ground conductor 1 and the ground conductor 3. It is known that the attenuation amount of such electromagnetic waves is small, and as a result, the electric characteristics are deteriorated.

In a fourth embodiment, a configuration in which coupling suppressing conductors are provided for forcibly block coupling among triplate lines will be explained. The coupling suppressing conductors are provided on both sides of each of the central conductors 5, 6, and 7 in order to suppress the electromagnetic waves called as the parallel-plate mode.

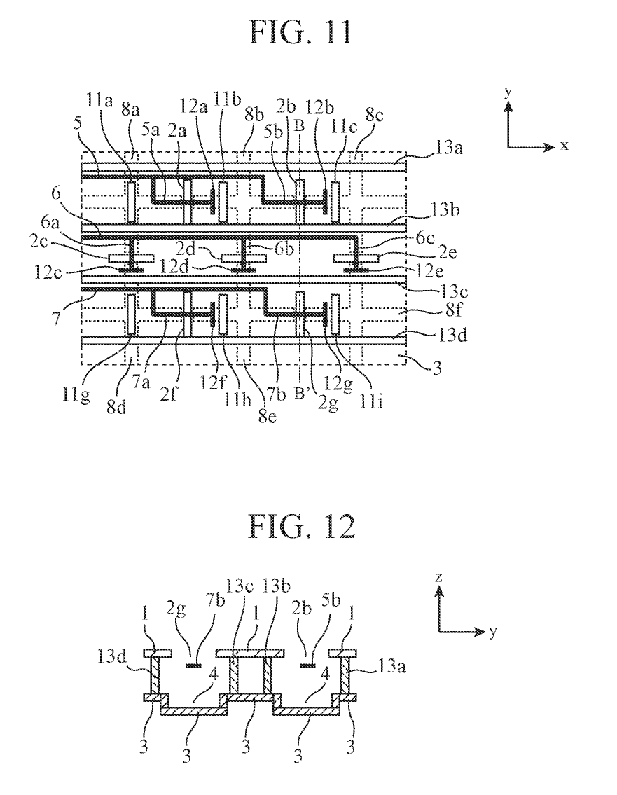

FIG. 11 is a top view illustrating an antenna device according to the fourth embodiment of the present invention. Note that, in FIG. 11, a state in which a ground conductor 1 is removed from the antenna device and the central conductors 5, 6, and 7 are visible is illustrated.

FIG. 12 is a cross-sectional view taken along line B-B′ in the antenna device in FIG. 11. Note that, FIG. 12 illustrates the antenna device in a state in which the ground conductor 1 is not removed.

In FIGS. 11 and 12, the same reference signs as those in FIGS. 1 to 10 represent the same or corresponding parts, so that the description thereof is omitted.

Side walls 13a, 13b, 13c, and 13d are used as the coupling suppressing conductors.

The side wall 13a is arranged on one side of the central conductor 5, one end thereof is connected to the ground conductor 1, and the other end thereof is connected to the ground conductor 3. The side wall 13b is arranged on the other side of the central conductor 5 and on one side of the central conductor 6, one end thereof is connected to the ground conductor 1, and the other end thereof is connected to the ground conductor 3.

The side wall 13c is arranged on the other side of the central conductor 6 and on one side of the central conductor 7, one end thereof is connected to the ground conductor 1, and the other end thereof is connected to the ground conductor 3. The side wall 13d is arranged on the other side of the central conductor 7, one end thereof is connected to the ground conductor 1, and the other end thereof is connected to the ground conductor 3.

In an example in FIG. 11, the side wall 13a is arranged on the upper side of the central conductor 5 on the drawing sheet, and the side wall 13b is arranged between the central conductor 5 and the central conductor 6. The side wall 13c is arranged between the central conductor 6 and the central conductor 7, and the side wall 13d is arranged on the lower side of the central conductor 7 on the drawing sheet.

In the antenna device in FIG. 11, the side walls 13a to 13d are applied to the antenna device of the third embodiment described before. However, the side walls 13a to 13d may be applied to the antenna devices of the first and second embodiments described before.

Next, the operation of the antenna device in this embodiment will be described.

Components other than the side walls 13a to 13d are similar to those in the first to third embodiments described before, the side walls 13a to 13d are mainly described below.

Since the side walls 13a to 13d are conductors arranged to isolate the central conductors 5, 6, and 7 from one another, the triplate line including the central conductor 5, the triplate line including the central conductor 6, and the triplate line including the central conductor 7 are isolated from one another.

By this configuration, even in a case in which the central conductors 5, 6, and 7 are arranged to be close to one another or even in a case in which discontinuous portions such as slots 2a to 2g and cavities 4 are present, the coupling among the triplate lines can be forcibly blocked.

Therefore, generation of electromagnetic waves between the ground conductor 1 and the ground conductor 3 called as the parallel-plate mode can be prevented.

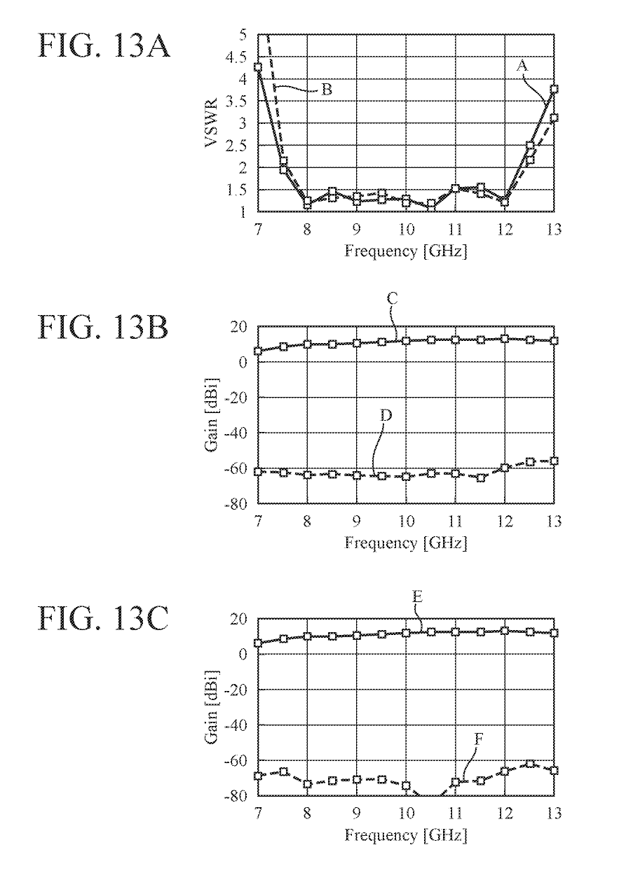

FIG. 13 is an illustrative view showing electromagnetic field simulation results for the antenna device according to the fourth embodiment of the present invention.

FIG. 13A illustrates reflection characteristics of the horizontal polarization A and reflection characteristics of the vertical polarization B, and FIG. 13B illustrates frequency characteristics of the main polarization gain C and the frequency characteristics of the cross polarization gain D in the boresight direction at the time of horizontal polarization excitation.

FIG. 13C illustrates frequency characteristics of the main polarization gain E and frequency characteristics of the cross polarization gain F in the boresight direction at the time of vertical polarization excitation.

In this electromagnetic field simulation, it is assumed that the depth of the cavity 4 is 0.08 wavelength.

From the reflection characteristics of the horizontal polarization A and the reflection characteristics of the vertical polarization B illustrated in FIG. 13A, the band in which the voltage standing wave ratio (VSWR) is equal to or lower than 1.5 is frequencies of approximately 8 to 12 [GHz]. That is, the band in which the VSWR is equal to or lower than 1.5 becomes a wide band of approximately 40% (=((12−8)/10)×100%).

For this reason, it can be said that in the antenna device in FIGS. 11 and 12, input/output impedance matching is achieved over a wide band.

From FIG. 13B, at the time of horizontal polarization excitation, an excellent cross polarization level of 50 dB or higher (=the frequency characteristic of the main polarization gain C—the frequency characteristic of the cross polarization gain D) is obtained.

From FIG. 13C, also at the time of vertical polarization excitation, an excellent cross polarization level of 50 dB or higher (=the frequency characteristic of the main polarization gain E—the frequency characteristic of the cross polarization gain F) is obtained.

Therefore, it is understood that the antenna device in FIGS. 11 and 12 can implement an excellent cross polarization level at both the time of horizontal polarization excitation and the time of vertical polarization excitation.

As can be understood from the above description, according to the fourth embodiment, as the conductor for forcibly blocking coupling among the triplate lines, the side walls 13a to 13d are arranged on both sides of each of the central conductors 5, 6, and 7, so that even in a case in which the central conductors 5, 6, and 7 are arranged to be close to each other, or even in a case in which discontinuous portions such as the slots 2a to 2g or the cavities 4 are present, there is an effect of preventing generation of electromagnetic waves between the ground conductor 1 and the ground conductors 3 called as the parallel-plate mode, thereby preventing deterioration in electric characteristics.

Therefore, it is possible to implement an antenna device capable of performing two-dimensional electronic scanning and orthogonal dual-polarization excitation with excellent electric characteristics.

In the fourth embodiment, the side walls 13a to 13d are arranged as coupling suppressing conductors. Alternatively, instead of the side walls 13a to 13d, two or more conductor bars and the like, through which the ground conductor 1 and the ground conductor 3 are electrically connected to each other, may be arranged as the coupling suppressing conductors on both sides of each of the central conductors 5, 6, and 7.

Further, instead of the side walls 13a to 13d, a choke structure having convex portions or concave portions may be formed on the ground conductor 1 or the ground conductor 3 as the coupling suppressing conductors.

Also in the case in which the conductor bars or the choke structure is provided, it is possible to prevent generation of electromagnetic waves between the ground conductor 1 and the ground conductor 3 called as the parallel-plate mode similarly to the case in which the side walls 13a to 13d are provided.

In the first to fourth embodiments described above, antenna devices capable of performing the orthogonal dual-polarization excitation are described. However, the present invention is not limited to an antenna device capable of performing the orthogonal dual-polarization excitation and may also be applicable to an antenna device of single polarization excitation.

For example, by removing the central conductors 6a, 6b, and 6c, the slots 2c, 2d, and 2e, and the three cavities 4 corresponding to the slots 2c, 2d, and 2e from the configuration shown in FIG. 2, it can operate as the antenna device of single polarization excitation.

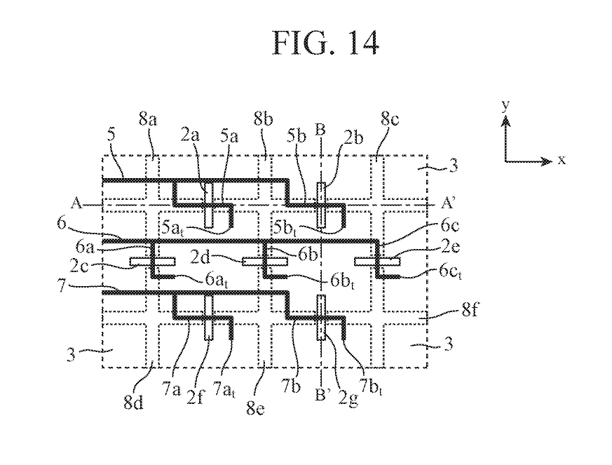

In the above-described first to fourth embodiments, the shape of each of the central conductors 5a, 5b, 6a, 6b, 6c, 7a, and 7b is linear. However, for example, as illustrated in FIG. 14, the ends 5aₜ, 5bₜ, 6aₜ, 6bₜ, 6cₜ, 7aₜ, and 7bₜ of the central conductors 5a, 5b, 6a, 6b, 6c, 7a, and 7b may be bent in the vicinity of the slots 2a to 2g, respectively.

Note that, FIG. 14 illustrates a state in which the ground conductor 1 is removed from the antenna device and the central conductors 5, 6, and 7 are visible.

In the above-described first to fourth embodiments, it is assumed that the central conductors 5a, 5b, 6a, 6b, 6c, 7a, and 7b and the central conductors 12a to 12g are supported by spacers and the like. However, the supporting means is not limited to the spacers and the like. For example, by arranging a dielectric substrate, on which the central conductors 5a, 5b, 6a, 6b, 6c, 7a, and 7b and the central conductors 12a to 12g are patterned, between the ground conductor 1 and the ground conductor 3, similar electric characteristics can be obtained.

Note that, in the present invention, the above embodiments can be freely combined, any component of each embodiment may be modified, or any component may be omitted in each embodiment without departing from the scope of the invention.

### INDUSTRIAL APPLICABILITY

The present invention is suitable for an antenna device in which a triplate line is used as the feeder line and reducing of the thickness of the feeder line is desired.

### REFERENCE SIGNS LIST

1: Ground conductor (first ground conductor), 2a to 2g: Slot (aperture), 3: Ground conductor (second ground conductor), 4: Cavity, 5, 5a, 5b: Central conductor (first central conductor), 6, 6a, 6b, 6c: Central conductor (first central conductor), 7, 7a, 7b: Central conductor (first central conductor), 5aₜ, 5bₜ, 6aₜ, 6bₜ, 6cₜ, 7aₜ, 7bₜ: Ends of central conductors 5a, 5b, 6a, 6b, 6c, 7a, and 7b, 8a to 8f: Tapered conductor, 11a to 11 i: Ground conductor (third ground conductor, disturbing conductor), 12a to 12g: Central conductor (second central conductor, disturbing conductor), 13a to 13d: Side wall (coupling suppressing conductor)

1-11. (canceled)

12. An antenna device comprising:
a first ground conductor having a slot for radiating an electromagnetic wave;
a second ground conductor on which a cavity recessed in a direction away from the first ground conductor is formed in a position opposite to the slot of the first ground conductor;
a first central conductor arranged between the first ground conductor and the second ground conductor in a position overlapping with the slot, the first central conductor being arranged such that the first ground conductor is closer to the first central conductor than the second ground conductor; and
a disturbing conductor disturbing an electromagnetic field between the first ground conductor and the second ground conductor.

13. The antenna device according to claim 12, wherein a plurality of antenna elements is arrayed in two-dimensional arrangement, each of the plurality of antenna elements including the slot of the first ground conductor and the first central conductor.

14. An antenna device comprising:
a first ground conductor having a slot for radiating an electromagnetic wave;
a second ground conductor on which a cavity recessed in a direction away from the first ground conductor is formed in a position opposite to the slot of the first ground conductor;
a first central conductor arranged between the first ground conductor and the second ground conductor in a position overlapping with the slot; and
a disturbing conductor disturbing an electromagnetic field between the first ground conductor and the second ground conductor.

15. The antenna device according to claim 14, comprising a third ground conductor, one end thereof being connected to the first ground conductor and another end thereof being connected to the second ground conductor, as the disturbing conductor.

16. The antenna device according to claim 14, comprising a third ground conductor, one end thereof being connected to the first ground conductor or the second ground conductor, and another end thereof extending toward the second ground conductor or the first ground conductor, as the disturbing conductor.

17. The antenna device according to claim 14, comprising a second central conductor, being connected to an end of the first central conductor, and arranged in the same plane as the first central conductor, as the disturbing conductor.

18. The antenna device according to claim 14, further comprising coupling suppressing conductors arranged on both sides of the first central conductor, one end thereof being connected to the first ground conductor, and another end thereof being connected to the second ground conductor.

19. The antenna device according to claim 14, wherein a plurality of antenna elements is arrayed in two-dimensional arrangement, each of the plurality of antenna elements including the slot of the first ground conductor and the first central conductor.
